(19) United States
(12) Patent Application Publication
(10) Pub. No.: US 2012/0161436 A1
(43) Pub. Date: Jun. 28, 2012

(54) ADAPTOR AND PIPE CONNECTOR USING THE SAME

(75) Inventor: Manouchehr Salehi-Bakhtiari, Hongkong (CN)

(73) Assignee: LA CASA ANGELA HOLDING LIMITED, Hongkong (CN)

(21) Appl. No.: 13/179,552

(22) Filed: Jul. 10, 2011

(30) Foreign Application Priority Data
Dec. 23, 2010 (CN) 201010601861.7

(51) Int. Cl. F16L 37/08; B60J 10/00

(52) U.S. Cl. 285/308; 285/344

(57) ABSTRACT

A pipe adaptor, including an adaptor body; an axial passage; a socket connecting segment for connecting with a socket; a pipe connecting segment for connecting with a pipe; a first O-shaped sealing ring; and a second O-shaped sealing ring. The axial passage is disposed in the adaptor body. The first O-shaped sealing ring is disposed on the socket connecting segment for forming a sealed connection with the internal wall of the socket. The second O-shaped sealing ring is disposed on the pipe connecting segment for forming a sealed connection with the internal wall of the pipe. A pipe connector including the pipe adaptor.

### CROSS-REFERENCE TO RELATED APPLICATIONS

Pursuant to 35 U.S.C. §119 and the Paris Convention Treaty, this application claims the benefit of Chinese Patent Application No. 201010601861.7 filed on Dec. 23, 2010, the contents of which are incorporated herein by reference.

### BACKGROUND OF THE INVENTION

1. Field of the Invention

This invention relates to a pipe connector, in particular relates to an adaptor and a pipe connector using the same.

2. Description of the Related Art

A pipe is one of essential facilities used in the industry, and a pipe connecting device, such as a socket, is an important device for connecting different pipes.

Nowadays, well known means of connecting pipes includes threaded connection (referring to metallic pipes) thermal welded joint (PP-R Pipe and PE pipe). Threaded connection of pipes is realized by screwing two pipes together via the internal thread of one of the pipes and the external thread of the other, and using Teflon belt for sealing, and thermal welded joint is realized by melting the joints of two pipe and connecting them together in molten state, so that the joint forms a sealed connection. However, the two above mentioned means of connection are very complex, and with bad quality of sealing, in addition, such means of connection may also bring inconvenience to the maintenance.

In order to meet different needs, improved ways of connecting pipes and the related devices are being expected.

Currently, more and more pipes multi-layer pipes with some poisonous metals such as aluminum are used for conveying water, in order to improve its strength. People usually cut off the multi-layer pipe in order to obtain a suitable length for installation. However, after the multi-layer pipe is cut off, the metal such as aluminum in the PEX pipe may be exposed. If the multi-layer pipe is used for drinking water, and the water contacts with the health risky metals, it may threaten people's health. Therefore, it is prohibited to use this kind of pipe for conveying drinking water.

The above mentioned prior arts may give the opportunity for drinking water to contact the health risky metals exposed from at least one of the ends of the adaptor, after the multi-layer pipe is inserted and the socket is injected with drinking water. It is because there is no component in the socket for blocking the end of pipe inserted from the water.

### SUMMARY OF THE INVENTION

In view of the above-described problem, it is one object of the invention to provide an adaptor with improved sealing, which may block the end of pipe inserted from the water injected, so that the water passing through the socket will not threaten people's health due to the fact that it contacts with the poisonous metal at such end.

To achieve the above objectives, in accordance with one embodiment of the invention provided is an adaptor, comprising an adaptor body; an axial passage; a socket connecting segment for connecting with a socket; a pipe connecting segment for connecting with a pipe; a first O-shaped sealing ring; and a second O-shaped sealing ring; wherein said axial passage is disposed in said adaptor body; said first O-shaped sealing ring is arraged disposed on said socket connecting segment for forming a sealed connection with the internal wall of said socket; and said second O-shaped sealing ring is arraged disposed on said pipe connecting segment for forming a sealed connection with the internal wall of said pipe.

The adaptor, wherein, a first positioning structure is circumferentially disposed on the external wall of the socket connecting segment for positioning the first O-shaped sealing ring; a second positioning structure is circumferentially disposed on the external wall of the pipe connecting segment for positioning the second O-shaped sealing ring.

The adaptor, wherein, the first positioning structure is a first groove that is circumferentially disposed, while the second positioning structure is a second groove that is circumferentially disposed; the first O-shaped sealing ring is disposed in the first groove, while the second O-shaped sealing ring is disposed in the second groove.

The adaptor, wherein, an adaptor flange is circumferentially disposed on the external wall of the socket connecting segment, and the first groove is circumferentially disposed on the adaptor flange.

The adaptor, wherein, the first groove comprises a pipe connecting segment side forming a first wall, and a socket connecting segment side forming a second wall; the first wall and the second wall are annular, and the diameter of the first wall is larger than that of the second wall; the first wall works with the socket to prevent the pipe from moving in the direction of entry.

A pipe connector using the adaptor comprising: a socket body having pipe locking assembly for locking the pipe inserted in the socket in the direction of pipe entry; a third O-shaped sealing ring for or forming a sealed connection with the external wall of said pipe; a O-shaped sealing ring stop shoulder; a pipe sealing segment; and an adaptor having an adaptor body, a socket connecting segment, a pipe connecting segment, a first O-shaped sealing ring and a second O-shaped sealing ring; wherein said O-shaped sealing ring stop shoulder is disposed on the internal wall of said socket body, for stopping said third O-shaped sealing ring from moving in the direction of pipe entry; said an axial passage is disposed in said adaptor body; said first O-shaped sealing ring is arraged disposed on said socket connecting segment for forming a sealed connection with the internal wall of said socket; and said second O-shaped sealing ring is arraged disposed on said pipe connecting segment for forming a sealed connection with the internal wall of said pipe.

The pipe connector, a first positioning structure is circumferentially disposed on the external wall of the socket connecting segment for positioning the first O-shaped sealing ring; a second positioning structure is circumferentially disposed on the external wall of the pipe connecting segment for positioning the second O-shaped sealing ring.

The pipe connector, the first positioning structure is a first groove that is circumferentially disposed, while the second positioning structure is a second groove that is circumferentially disposed; the first O-shaped sealing ring is disposed in the first groove, while the second O-shaped sealing ring is disposed in the second groove.

The pipe connector, wherein, an adaptor flange is circumferentially disposed on the external wall of the socket connecting segment, and the first groove is circumferentially disposed on the adaptor flange; a pipe stopping member is disposed on the internal wall of the socket body, for stopping the adaptor from moving in the direction of pipe entry.

The pipe connector, the first groove comprises a pipe connecting segment side forming a first wall, and a socket connecting segment side forming a second wall; the first wall and the second wall are annular, and the diameter of the first wall is larger than that of the second wall; the pipe stop member is a pipe stop member with a annular shape that is circumferentially disposed; the internal diameter of the pipe stop member is larger than that of the second wall, but smaller than that of the first wall; the first O-shaped sealing ring is in sealed connection with the internal wall of the pipe stop member; the first wall works with the pipe stop member to prevent the pipe from moving in the direction of entry.

The pipe connector, the pipe locking assembly comprises a locking cap for preventing the components in the pipe connector from escaping , a locking cap stop member disposed at the end of the socket body where the pipe enters, for preventing the locking cap from escaping; a demounting ring for unlocking the pipe; a grab ring, comprising a flange and a plurality of teeth disposed on the flange and fixed to the external wall of the pipe; a retainer, in moveable connection with the internal wall of the socket body, for stopping the grab ring from moving in the direction of pipe entry; a retainer stop shoulder disposed on the internal wall of the socket body for stopping the retainer from moving in the direction of pipe entry.

The pipe connector, wherein, the socket body comprises an O-shaped sealing ring location and a step; the O-shaped sealing ring location is disposed between the O-shaped sealing ring stop shoulder and retainer stop shoulder; the step is in sealed connection with the O-shaped sealing ring location; the step is disposed at the end of the O-shaped sealing ring stop shoulder; the O-shaped sealing ring stop shoulder is close to to the third O-shaped sealing ring; and the step always keeps in sealed connection with the O-shaped sealing ring location.

The pipe connector, wherein, said socket further comprises: a locking cap stop shoulder, a convex part, and the demounting ring having a sharp angle; the locking cap stop shoulder is disposed on the internal wall of the socket body, between the grab ring and the locking cap, for stopping the locking cap from moving in the direction of pipe entry; the convex part is disposed on the external wall of the demounting ring for working with the locking cap to avoid the demounting ring of escaping from the socket; the sharp angle disposed at the end of the demount ring is close to the grab ring; the gap between the O-shaped sealing ring stop shoulder and the retainer is no narrower than the axial width of the third O-shaped sealing ring that is compressed when the pipe passes through the third O-shaped sealing ring; the internal diameter of the teeth in their initial state is smaller than the external diameter of the pipe; the internal diameter of the third O-shaped sealing ring is smaller than the external diameter of the pipe; the internal diameter of the demounting ring is larger than the external diameter of the pipe; the retainer is annular; and the taper having a ramp that coordinates with the teeth.

Advantages of the invention comprise:

1. The first O-shaped sealing ring is disposed on the socket connecting segment for forming a sealed connection with the internal wall of the pipe connector; the second O-shaped sealing ring is disposed on the pipe connecting segment for forming a sealed connection with the internal wall of the pipe. The adaptor with this design can ensure the liquid (drinking water) never flows in from any end of the adaptor to contact the metal exposed at the end of pipe, so that it may avoid the fact that people's health may be threatened by the liquid (drinking water) after contacting with the metal at the end of pipe. In addition, the first O-shaped sealing ring disposed circumferentially on the external wall of the adaptor, may not only ensure that the O-shaped sealing ring always contacts with the internal wall of pipe connector, even if there is a slight relative movement between the adaptor and the internal wall of pipe connector; but also increases the pressure on the internal wall of pipe connector, so as to increases the friction between the adaptor and such internal wall, thereby improve the tightness of the system. In addition, the adaptor mentioned above allows no need to use another type of pipe without health risk substance such as aluminum at the end, when conveying drinking water, so as to reduce the cost of carrying 2 types of pipes.

2. The first positioning structure is circumferentially disposed on the external wall of the socket connecting segment for positioning the first O-shaped sealing ring; a second positioning structure is circumferentially disposed on the external wall of the pipe connecting segment for positioning the second O-shaped sealing ring. The adaptor with this design not only ensure no relative movement between the second O-shaped sealing ring and the adaptor, so as to ensure the quality of sealing between the pipe and the adaptor, but also ensure no axially relative movement between the first O-shaped sealing ring and the adaptor, so as to keep the first O-shaped sealing ring always staying on the external wall of the adaptor, thereby ensuring the sealing between the adaptor and the internal wall of pipe connector.

3. The first positioning structure is a first groove that is circumferentially disposed, while the second positioning structure is a second groove that is circumferentially disposed; the first O-shaped sealing ring is disposed in the first groove, while the second O-shaped sealing ring is disposed in the second groove; wherein, the groove used to be the positioning structure can be easily formed, and also can ensure the quality of sealing of system.

4. The adaptor flange is circumferentially disposed on the external wall of the socket connecting segment, and the first groove is circumferentially disposed on the adaptor flange. The adaptor with this design may block the pipe from moving in the direction of pipe entry, and also may keep the pipe in correct position of being sealed internally.

5. The first groove comprises a pipe connecting segment side forming a first wall, and a socket connecting segment side forming a second wall; the first wall and the second wall are annular, and the diameter of the first wall is larger than that of the second wall; the first wall works with the pipe connector to prevent the pipe from moving in the direction of entry. The adaptor with this design can allow a step structure formed by the first wall, the second wall and the O-shaped sealing ring disposed in the first groove, so that it can improve the compactness between the adaptor and the pipe stopping component disposed on the internal wall of pipe connector.

6. A pipe connector comprising: a socket body comprising in the direction of pipe entry: pipe locking assembly for locking the pipe inserted in the pipe connector; a third O-shaped sealing ring for or forming a sealed connection with the external wall of the pipe; a pipe sealing segment; wherein, further configuring an adaptor; the adaptor comprises an adaptor body with a axial passage in it, which also comprises a socket connecting segment for connecting with a pipe connector, and a pipe connecting segment for connecting with a pipe; wherein, a first O-shaped sealing ring is disposed on the socket connecting segment for forming a sealed connection with the internal wall of the pipe connector; a second O-shaped sealing ring is disposed on the pipe connecting segment for forming a sealed connection with the internal wall of the pipe. The pipe connector also comprises the above mentioned adaptor. The pipe connector with this design can ensure the liquid (drinking water) never flows in from any end of the adaptor to contact the metal exposed at the end of pipe, so that it may avoid the fact that people's health may be threatened by the liquid (drinking water) after contacting with the metal at the end of pipe. In addition, the first O-shaped sealing ring disposed circumferentially on the external wall of the adaptor, may not only ensure that the O-shaped sealing ring always contacts with the internal wall of pipe connector, even if there is a slight relative movement between the adaptor and the internal wall of pipe connector; but also increases the pressure on the internal wall of pipe connector, so as to increases the friction between the adaptor and such internal wall, thereby improve the tightness of the system.

7. The pipe connector comprises an adaptor, wherein the first positioning structure is circumferentially disposed on the external wall of the socket connecting segment for positioning the first O-shaped sealing ring; and the second positioning structure is circumferentially disposed on the external wall of the pipe connecting segment for positioning the second O-shaped sealing ring. The pipe connector with this design not only ensure no relative movement between the second O-shaped sealing ring and the adaptor, so as to ensure the quality of sealing between the pipe and the adaptor, but also ensure no axially relative movement between the first O-shaped sealing ring and the adaptor, so as to keep the first O-shaped sealing ring always staying on the external wall of the adaptor, thereby ensuring the sealing between the adaptor and the internal wall of pipe connector.

8. The pipe connector, wherein, the adaptor flange is circumferentially disposed on the external wall of the socket connecting segment, and the first groove is circumferentially disposed on the adaptor flange; the pipe stop member is disposed on the internal wall of the socket body, for stopping the adaptor from moving in the direction of pipe entry; the pipe connector with this design may the adaptor and the pipe locked between the pipe stop member and the pipe locking assembly, so as to improve the tightness of the system.

9. The pipe connector, wherein, comprises an O-shaped sealing ring location disposed between the O-shaped sealing ring stop shoulder and the retainer stop shoulder, a step which is in sealed connection with the O-shaped sealing ring location, is disposed at the end of the O-shaped sealing ring stop shoulder close to the third O-shaped sealing ring; wherein, the a step keeps in sealed connection with the O-shaped sealing ring location. This design may improve the sealing between the third O-shaped sealing ring and the internal wall of pipe connector, so as to ensure the sealing of system.

10. If the gap between the O-shaped sealing ring stop shoulder and the retainer is as wide as the axial width of the O-shaped sealing ring that is compressed when the pipe enters the pipe connector, the pressure generated by the third O-shaped sealing ring is not so large, and this may ease the insertion of pipe.

11. As the internal diameter of the teeth in their initial state is smaller than the external diameter of the pipe, the teeth of the grab ring can grab on the external wall of the pipe. As the internal diameter of the O-shaped sealing ring is smaller than the external diameter of the pipe, the O-shaped sealing ring can form a sealed connection with the external wall of the pipe, and as the internal diameter of the demounting ring is larger than the external diameter of the pipe, a sufficient clearance forms between the demounting ring and the pipe allowing an unrestricted entry of the pipe.

12. The retainer is annular, and contains a ramp that coordinates with the teeth. This allows the teeth of the grab ring to flex when pushed by the pipe being inserted. The demounting ring containing a sharp angle at the end of the demount ring close to the O-shaped sealing ring ensures least contact with the teeth of the grab ring.

### BRIEF DESCRIPTION OF THE DRAWINGS

Detailed description will be given below in conjunction with accompanying drawings:

FIG. 1 illustrates the adaptor with a adaptor flange;

FIG. 2 illustrates the adaptor with the first wall and the second wall;

FIG. 3 illustrates the adaptor in FIG. 1 connected with pipe in working status;

FIG. 4 illustrates the working status of the adaptor in FIG. 2 connected with pipe;

FIG. 5 illustrates the pipe connector without the adaptor installed; and

FIG. 6 illustrates the pipe connector with the first wall and the second wall in working status.

In the drawings, the following reference numbers are used:

1—socket body, 2—third O-shaped sealing ring, 3—retainer, 4—grab ring, 5—locking cap, 6—demounting ring, 7—O-shaped sealing ring stop shoulder, 8—retainer stop shoulder, 9—locking cap stop member, 1O—tooth, 11—pipe stop member, 12—grab ring flange, 13—pipe, 14—O-shaped sealing ring location, 15—step, 16—convex part, 17—locking cap stop shoulder; 101—adaptor body, 102—passage, 103—first groove, 104—second groove, 105—first O-shaped sealing ring, 106—second O-shaped sealing ring, 107—adaptor flange, 108—first wall, 109—second wall, 11O—socket connecting segment, 111—pipe connecting segment, 12O—pipe sealing segment.

### DETAILED DESCRIPTION OF THE EMBODIMENTS

### Example 1

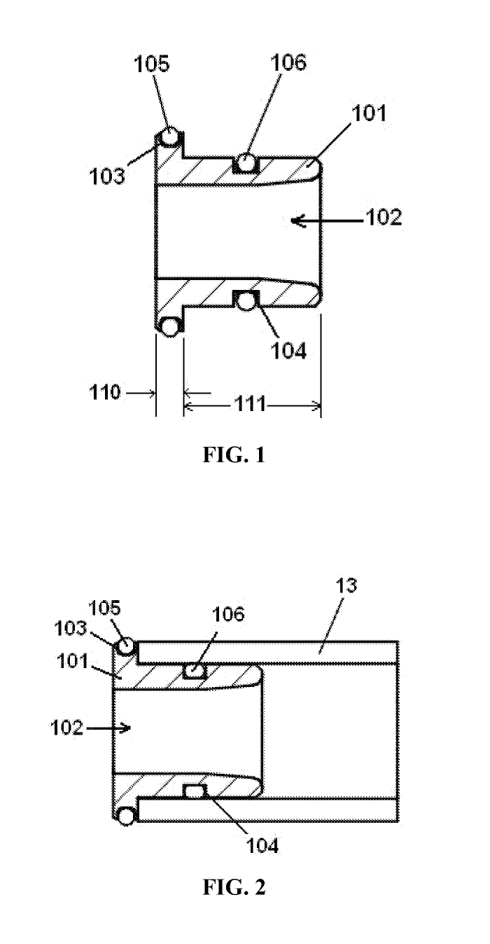

Referring to FIG. 1, the adaptor comprises an adaptor body 101 with a axial passage 102 in it, which also comprises a socket connecting segment 110 for connecting with a pipe connector, and a pipe connecting segment 111 for connecting with a pipe; an adaptor flange 107 is circumferentially disposed on the external wall of the socket connecting segment 110.

Referring to FIG. 2, a first O-shaped sealing ring 105 is disposed on the socket connecting segment 110 for forming a sealed connection with the internal wall of the pipe connector; a second O-shaped sealing ring 106 is disposed on the pipe connecting segment 111 for forming a sealed connection with the internal wall of the pipe.

A first positioning structure is circumferentially disposed on the external wall of the socket connecting segment 110 for positioning the first O-shaped sealing ring 105; a second positioning structure is circumferentially disposed on the external wall of the pipe connecting segment 111 for positioning the second O-shaped sealing ring 106.

The first positioning structure is a first groove 103 that is circumferentially disposed on the adaptor flange 107, while the second positioning structure is a second groove 104 that is circumferentially disposed on the external wall of the adaptor body 101; the first O-shaped sealing ring 105 is disposed in the first groove 103, while the second O-shaped sealing ring 106 is disposed in the second groove 104.

The adaptor with this design can ensure the liquid (drinking water) never flows in from any end of the adaptor to contact the metal exposed at the end of pipe, so that it may avoid the fact that people's health may be threatened by the liquid (drinking water) after contacting with the metal at the end of pipe. In addition, the first O-shaped sealing ring 105 disposed circumferentially on the external wall of the adaptor, may not only ensure that the O-shaped sealing ring always contacts with the internal wall of pipe connector, even if there is a slight relative movement between the adaptor and the internal wall of pipe connector; but also increases the pressure on the internal wall of pipe connector, so as to increases the friction between the adaptor and such internal wall, thereby improve the tightness of the system.

The first groove 103 and the second groove 104 not only ensure no relative movement between the second O-shaped sealing ring 106 and the adaptor, so as to ensure the quality of sealing between the pipe and the adaptor, but also ensure no axially relative movement between the first O-shaped sealing ring 105 and the adaptor, so as to keep the first O-shaped sealing ring 105 always staying on the external wall of the adaptor, thereby ensuring the sealing between the adaptor and the internal wall of pipe connector.

### Example 2

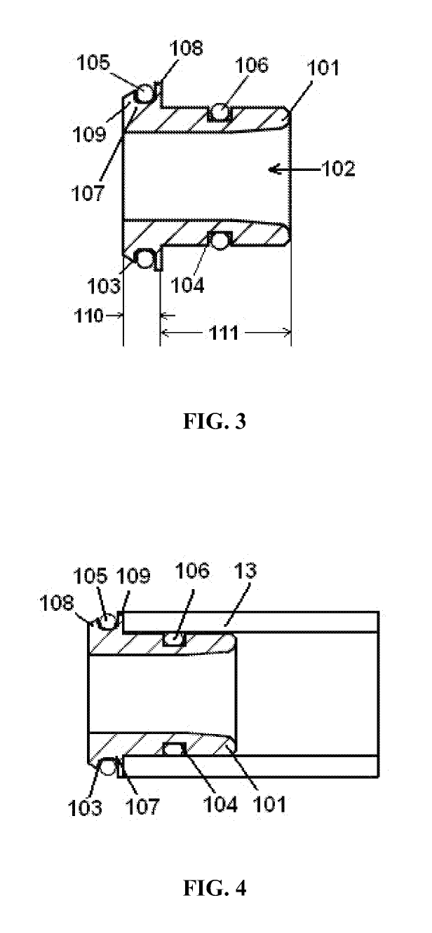

Referring to FIG. 3, the adaptor comprises an adaptor body 101 with a axial passage 102 in it, which also comprises a socket connecting segment 110 for connecting with a pipe connector, and a pipe connecting segment 111 for connecting with a pipe; an adaptor flange 107 is circumferentially disposed on the external wall of the socket connecting segment 110.

A first O-shaped sealing ring 105 is disposed on the socket connecting segment 110 for forming a sealed connection with the internal wall of the pipe connector; a second O-shaped sealing ring 106 is disposed on the pipe connecting segment 111 for forming a sealed connection with the internal wall of the pipe.

A first positioning structure is circumferentially disposed on the external wall of the socket connecting segment 110 for positioning the first O-shaped sealing ring 105; a second positioning structure is circumferentially disposed on the external wall of the pipe connecting segment 111 for positioning the second O-shaped sealing ring 106.

Referring to FIG. 4, the first positioning structure is a first groove 103 that is circumferentially disposed on the adaptor flange 107, while the second positioning structure is a second groove 104 that is circumferentially disposed on the external wall of the adaptor body 101; the first O-shaped sealing ring 105 is disposed in the first groove 103, while the second O-shaped sealing ring 106 is disposed in the second groove 104.

The first groove 103 comprises a pipe connecting segment 111 side forming a first wall 108, and a socket connecting segment 110 side forming a second wall 109; the first wall 108 and the second wall 109 are annular, and the diameter of the first wall 108 is larger than that of the second wall 109; the first wall 108 works with the pipe connector to prevent the pipe from moving in the direction of entry.

### Example 3

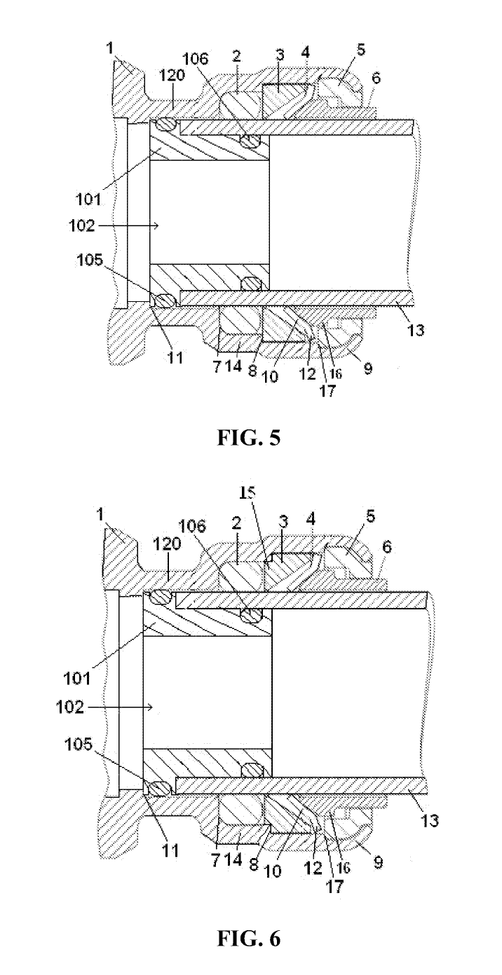

Referring to FIG. 5, a pipe connector comprises: a socket body 1. The socket body 1 comprises, in the direction of pipe entry: a locking cap 5 for preventing the components in the pipe connector from escaping, a locking cap stop member 9 disposed at the end of the pipe connector where the pipe 13 enters, for preventing the locking cap 5 from escaping; a demounting ring 6 for unlocking the pipe 13; a grab ring 4, comprising a flange 12 and a plurality of teeth 10 set on the flange for grabbing on the external wall of the pipe 13; a retainer 3, in moveable connection with the internal wall of the socket body 1, for stopping the grab ring 4 from moving in the direction of pipe entry; a retainer stop shoulder 8 disposed on the internal wall of the socket body 1 for stopping the retainer 3 from moving in the direction of pipe entry; the arrangement of the retainer stop shoulder 8 and the and locking cap 5 allows free axial movement of the grab ring 4 and the retainer 3 between them.

A third O-shaped sealing ring 2 for forming a sealed connection with the external wall of the pipe 13; a O-shaped sealing ring stop shoulder 7, disposed on the internal wall of the socket body 1, for stopping the third O-shaped sealing ring 2 from moving in the direction of pipe entry.

The socket body 1 further comprises a pipe connecting segment 120.

The pipe connector also comprises an adaptor; the adaptor, comprises an adaptor body 101 with a axial passage 102 in it, which also comprises a socket connecting segment 110 for connecting with a pipe connector, and a pipe connecting segment 111 for connecting with a pipe; an adaptor flange 107 is circumferentially disposed on the external wall of the socket connecting segment 110.

Referring to FIG. 2, a first O-shaped sealing ring 105 is disposed on the socket connecting segment 110 for forming a sealed connection with the internal wall of the pipe connector; a second O-shaped sealing ring 106 is disposed on the pipe connecting segment 111 for forming a sealed connection with the internal wall of the pipe.

A first positioning structure is circumferentially disposed on the external wall of the socket connecting segment 110 for positioning the first O-shaped sealing ring 105; a second positioning structure is circumferentially disposed on the external wall of the pipe connecting segment 111 for positioning the second O-shaped sealing ring 106.

The first positioning structure is a first groove 103 that is circumferentially disposed on the adaptor flange 107, while the second positioning structure is a second groove 104 that is circumferentially disposed on the external wall of the adaptor body 101; the first O-shaped sealing ring 105 is disposed in the first groove 103, while the second O-shaped sealing ring 106 is disposed in the second groove 104.

A pipe stop member 11 is disposed on the internal wall of the socket body 1, for stopping the adaptor and the pipe 13 from moving in the direction of pipe entry.

The length of adaptor is larger than the distance between the pipe stop member 11 and the third O-shaped sealing ring 2.

The gap between the O-shaped sealing ring stop shoulder 7 and the retainer 3 is wider than the axial width of the third O-shaped sealing ring 2 that is compressed when the pipe 13 enters the pipe connector and passes through the Third O-shaped sealing ring 2. It allows the free compression of the Third O-shaped sealing ring 2, and the Third O-shaped sealing ring 2 is separated from the retainer 3.

The internal diameter of the teeth 10 in their initial state is smaller than the external diameter of the pipe 13, the internal diameter of the third O-shaped sealing ring 2 is smaller than the external diameter of the pipe 13, and the internal diameter of the demounting ring 6 is larger than the external diameter of the pipe 13.

The retainer 3 is annular, and contains a ramp that coordinates with the teeth 10.

The pipe connector furthering comprises a locking cap shoulder 17, disposed on the internal wall of the socket body 1, between the grab ring 4 and the locking cap 5, for stopping the locking cap 5 from moving in the direction of pipe entry; a convex part 16, disposed on the external wall of the demounting ring for working with the locking cap 5 to avoid the demounting ring 6 of escaping from the pipe connector.

The demounting ring 6 contains a sharp angle at the end of the demount ring 6 close to the grab ring 4.

In the adaptor, a first O-shaped sealing ring 105 is disposed on the socket connecting segment for forming a sealed connection with the internal wall of the pipe sealing segment 120.

When pipe 13 enters the pipe connector, it initially passes through the demounting ring 6; then with the entry of the pipe 13, the external wall of the pipe 13 gets to contact the teeth 10 of the grab ring 4, and this stage the teeth of grab ring may grab on the external wall of pipe, with further entry of the pipe 13, it passes through the retainer 3 and the third O-shaped sealing ring 2, then reaches the adaptor flange 107.

In order to take the pipe 13 out of the pipe connector, the demounting ring 6 is pushed in the direction of pipe entry, and then the end of the demounting ring 6 close to the grab ring pushes the teeth to separate them from the external wall of the pipe 13, so that the pipe 13 is unlocked and can be taken out of the pipe connector.

The pipe 13 preferably can be multi-layer pipe.

The pipe connector with the adaptor in this embodiment can ensure the liquid (drinking water) never flows in from any end of the adaptor to contact the metal exposed at the end of pipe, so that it may avoid the fact that people's health may be threatened by the liquid (drinking water) after contacting with the metal at the end of pipe. In addition, the first O-shaped sealing ring 105 disposed circumferentially on the external wall of the adaptor, may not only ensure that the O-shaped sealing ring always contacts with the internal wall of pipe connector, even if there is a slight relative movement between the adaptor and the internal wall of pipe connector; but also increases the pressure on the internal wall of pipe connector, so as to increases the friction between the adaptor and such internal wall, thereby improve the tightness of the system.

As the internal diameter of the teeth in their initial state is smaller than the external diameter of the pipe, the teeth of the grab ring can grab on the external wall of the pipe. As the internal diameter of the third O-shaped sealing ring is smaller than the external diameter of the pipe, the third O-shaped sealing ring can form a sealed connection with the external wall of the pipe, and as the internal diameter of the demounting ring is larger than the external diameter of the pipe, a sufficient clearance forms between the demounting ring and the pipe allowing an unrestricted entry of the pipe.

The retainer is annular, and contains a ramp that coordinates with the teeth. This allows the teeth of the grab ring to flex when pushed by the pipe being inserted.

The demounting ring containing a sharp angle at the end of the demount ring close to the O-shaped sealing ring ensures least contact with the teeth of the grab ring.

### Example 4

Referring to FIG. 6, a pipe connector comprises a socket body 1 in which in the direction of pipe entry, configuring in sequence a locking cap 5 for preventing the components such as demounting ring 6, grab ring 4, retainer 3 and third O-shaped sealing ring 2 in the pipe connector from escaping, a locking cap stop member 9 disposed at the end of the pipe connector where the pipe 13 enters, for preventing the locking cap 5 from escaping; a demounting ring 6 for unlocking the pipe 13; a grab ring 4, comprising a flange 12 and a plurality of teeth 10 disposed on the flange for grabbing on the external wall of the pipe 13; a retainer 3, in moveable connection with the internal wall of the socket body 1, for stopping the grab ring 4 from moving in the direction of pipe entry; a retainer stop shoulder 8 disposed on the internal wall of said socket body 1 for stopping said retainer 3 from moving in the direction of pipe entry; the arrangement of said retainer stop shoulder 8 and said and locking cap 5 allows free axial movement of said grab ring 4 and said retainer 3 between them; a third O-shaped sealing ring 2 for forming a sealed connection with the external wall of said pipe 13.

A O-shaped sealing ring stop shoulder 7, is disposed on the internal wall of the socket body 1, for stopping the third O-shaped sealing ring 2 from moving in the direction of pipe entry.

The socket body 1 further comprises a pipe connecting segment 120.

The pipe connector further comprises an adaptor, which comprises an adaptor body 101 with a axial passage 102 in it, which also comprises a socket connecting segment 110 for connecting with a pipe connector, and a pipe connecting segment 111 for connecting with a pipe; an adaptor flange 107 is circumferentially disposed on the external wall of the socket connecting segment 110.

A first O-shaped sealing ring 105 is disposed on the socket connecting segment 110 for forming a sealed connection with the internal wall of the pipe connector; a second O-shaped sealing ring 106 is disposed on the pipe connecting segment 111 for forming a sealed connection with the internal wall of the pipe.

A first positioning structure is circumferentially disposed on the external wall of the socket connecting segment 110 for positioning the first O-shaped sealing ring 105; a second positioning structure is circumferentially disposed on the external wall of the pipe connecting segment 111 for positioning the second O-shaped sealing ring 106.

Referring to FIG. 4, the first positioning structure is a first groove 103 that is circumferentially disposed on the adaptor flange 107, while the second positioning structure is a second groove 104 that is circumferentially disposed on the external wall of the adaptor body 101; the first O-shaped sealing ring 105 is disposed in the first groove 103, while the second O-shaped sealing ring 106 is disposed in the second groove 104.

The first groove 103 comprises a pipe connecting segment 111 side forming a first wall 108, and a socket connecting segment 110 side forming a second wall 109; the first wall 108 and the second wall 109 are annular, and the diameter of the first wall 108 is larger than that of the second wall 109.

A pipe stop member 11 is disposed on the internal wall of the socket body 1, for stopping the adaptor and the pipe 13 from moving in the direction of pipe entry.

The length of adaptor is larger than the distance between the pipe stop member 11 and the third O-shaped sealing ring 2.

The pipe connector also comprising an O-shaped sealing ring location 14 disposed between the O-shaped sealing ring stop shoulder 7 and retainer stop shoulder 8, a step 15 which is in sealed connection with the O-shaped sealing ring location 14, is disposed at the end of the O-shaped sealing ring stop shoulder 7 close to the third O-shaped sealing ring 2; wherein, the step 15 always keeps in sealed connection with the O-shaped sealing ring location.

The gap between the O-shaped sealing ring stop shoulder 7 and the retainer 3 is wider than the axial width of the third O-shaped sealing ring 2 that is compressed when the pipe 13 enters the pipe connector and passes through the third O-shaped sealing ring 2.

As a preferred design that the gap between the O-shaped sealing ring stop shoulder 7 and the retainer 3 is as wide as the axial width of the third O-shaped sealing ring 2 that is compressed when the pipe 13 enters the pipe connector and passes through the third O-shaped sealing ring 2. It allows the free compression of the third O-shaped sealing ring 2.

The internal diameter of the teeth 10 in their initial state is smaller than the external diameter of the pipe 13, the internal diameter of the third O-shaped sealing ring 2 is smaller than the external diameter of the pipe 13, and the internal diameter of the demounting ring 6 is larger than the external diameter of the pipe 13.

The retainer 3 is annular, and contains a ramp that coordinates with the teeth 10.

The pipe connector furthering comprises a locking cap stop shoulder 17, disposed on the internal wall of the socket body 1, between the grab ring 4 and the locking cap 5, for stopping the locking cap 5 from moving in the direction of pipe entry; a convex part 16, disposed on the external wall of the demounting ring for working with the locking cap 5 to avoid the demounting ring 6 of escaping from the pipe connector.

The demounting ring 6 contains a sharp angle at the end of the demount ring 6 close to the O-shaped sealing ring 4.

When pipe 13 enters the pipe connector, it initially passes through the demounting ring 6; then with the entry of the pipe 13, the external wall of the pipe 13 gets to contact the teeth 10 of the grab ring 4. With further entry of the pipe 13, it passes through the retainer 3 and the third O-shaped sealing ring, then reaches the adaptor flange 107; at this moment, the first O-shaped sealing ring is in sealed connection with the internal wall of the pipe stop member, and the first wall 108 works with the pipe connector to prevent the pipe from moving in the direction of entry.

In order to take the pipe 13 out of the pipe connector, the demounting ring 6 is pushed in the direction of pipe entry, and then the end of the demounting ring 6 close to the grab ring pushes the teeth to separate them from the external wall of the pipe 13, so that the pipe 13 can be taken out of the pipe connector. The pipe 13 preferably can be multi-layer pipe.

The pipe connector with the adaptor in this embodiment can ensure the liquid (drinking water) never flows in from any end of the adaptor to contact the metal exposed at the end of pipe, so that it may avoid the fact that people's health may be threatened by the liquid (drinking water) after contacting with the metal at the end of pipe. In addition, the first O-shaped sealing ring 105 disposed circumferentially on the external wall of the adaptor, may not only ensure that the third O-shaped sealing ring 2 always contacts with the internal wall of pipe connector, even if there is a slight relative movement between the adaptor and the internal wall of pipe connector; but also increases the pressure on the internal wall of pipe connector, so as to increases the friction between the adaptor and such internal wall, thereby improve the tightness of the system.

The pipe connector, wherein, comprises an O-shaped sealing ring location disposed between the O-shaped sealing ring stop shoulder and the retainer stop shoulder, a step which is in sealed connection with the O-shaped sealing ring location, is disposed at the end of the O-shaped sealing ring stop shoulder close to the third O-shaped sealing ring; wherein, the step keeps in sealed connection with the O-shaped sealing ring location. This design may improve the sealing between the third O-shaped sealing ring and the internal wall of pipe connector, so as to ensure the sealing of system.

If the gap between the O-shaped sealing ring stop shoulder and the retainer is as wide as the axial width of the O-shaped sealing ring that is compressed when the pipe enters the pipe connector, the pressure generated by the third O-shaped sealing ring is not so large, and this may ease the insertion of pipe.

As the internal diameter of the teeth in their initial state is smaller than the external diameter of the pipe, the teeth of the grab ring can grab on the external wall of the pipe. As the internal diameter of the third O-shaped sealing ring is smaller than the external diameter of the pipe, the third O-shaped sealing ring can form a sealed connection with the external wall of the pipe, and as the internal diameter of the demounting ring is larger than the external diameter of the pipe, a sufficient clearance forms between the demounting ring and the pipe allowing an unrestricted entry of the pipe.

The retainer is annular, and contains a ramp that coordinates with the teeth. This allows the teeth of the grab ring to flex when pushed by the pipe being inserted.

The demounting ring containing a sharp angle at the end of the demount ring close to the third O-shaped sealing ring ensures least contact with the teeth of the grab ring.

The foregoing description, for purpose of explanation, has been described with reference to specific embodiments. However, the illustrative discussions above are not intended to be exhaustive or to limit the invention to the precise forms disclosed. Many modifications and variations are possible in view of the above teachings. The embodiments were chosen and described in order to best explain the principles of the invention and its practical applications, to thereby enable others skilled in the art to best utilize the invention and various embodiments with various modifications as are suited to the particular use contemplated.

While particular embodiments of the invention have been shown and described, it will be obvious to those skilled in the art that changes and modifications may be made without departing from the invention in its broader aspects, and therefore, the aim in the appended claims is to cover all such changes and modifications that fall within the true spirit and scope of the invention.

1. An adaptor, comprising
an adaptor body;
an axial passage;
a socket connecting segment for connecting with a socket;
a pipe connecting segment for connecting with a pipe;
a first O-shaped sealing ring; and
a second O-shaped sealing ring;
wherein
said axial passage is disposed in said adaptor body;
said first O-shaped sealing ring is disposed on said socket connecting segment for forming a sealed connection with the internal wall of said socket; and
said second O-shaped sealing ring is disposed on said pipe connecting segment for forming a sealed connection with the internal wall of said pipe.

2. The adaptor of claim 1, wherein a first positioning structure is circumferentially disposed on the external wall of said socket connecting segment for positioning said first O-shaped sealing ring; and a second positioning structure is circumferentially disposed on the external wall of said pipe connecting segment for positioning said second O-shaped sealing ring.

3. The adaptor of claim 2, wherein said first positioning structure is a first groove that is circumferentially disposed, while said second positioning structure is a second groove that is circumferentially disposed; and said first O-shaped sealing ring is disposed in said first groove, while said second O-shaped sealing ring is disposed in said second groove.

4. The adaptor of claim 3, wherein an adaptor flange is circumferentially disposed on the external wall of said socket connecting segment, and said first groove is circumferentially disposed on said adaptor flange.

5. The adaptor of claim 4, wherein said first groove comprises a pipe connecting segment side forming a first wall, and a socket connecting segment side forming a second wall; said first wall and said second wall are annular, and the diameter of said first wall is larger than that of said second wall; said first wall works with said socket to prevent the pipe from moving in the direction of entry.

6. A pipe connector comprising the adaptor of claim 1, the pipe connector comprising:
a socket body having pipe locking assembly for locking the pipe inserted in the socket in the direction of pipe entry;
a third O-shaped sealing ring for or forming a sealed connection with the external wall of said pipe;
a O-shaped sealing ring stop shoulder;
a pipe sealing segment; and
an adaptor having an adaptor body, a socket connecting segment, a pipe connecting segment, a first O-shaped sealing ring and a second O-shaped sealing ring;
wherein
said O-shaped sealing ring stop shoulder is disposed on the internal wall of said socket body, for stopping said third O-shaped sealing ring from moving in the direction of pipe entry;
said an axial passage is disposed in said adaptor body;
said first O-shaped sealing ring is arraged disposed on said socket connecting segment for forming a sealed connection with the internal wall of said socket; and
said second O-shaped sealing ring is arraged disposed on said pipe connecting segment for forming a sealed connection with the internal wall of said pipe.

7. The pipe connector of claim 6, wherein a first positioning structure is circumferentially disposed on the external wall of said socket connecting segment for positioning said first O-shaped sealing ring; and a second positioning structure is circumferentially disposed on the external wall of said pipe connecting segment for positioning said second O-shaped sealing ring.

8. The pipe connector of claim 7, wherein said first positioning structure is a first groove that is circumferentially disposed, while said second positioning structure is a second groove that is circumferentially disposed; and said first O-shaped sealing ring is disposed in said first groove, while said second O-shaped sealing ring is disposed in said second groove.

9. The pipe connector of claim 8, wherein an adaptor flange is circumferentially disposed on the external wall of said socket connecting segment, said first groove is circumferentially disposed on said adaptor flange; and a pipe stop member is disposed on the internal wall of said socket body, for stopping said adaptor from moving in the direction of pipe entry.

10. The pipe connector of claim 9, wherein, said first groove comprises a pipe connecting segment side forming a first wall, and a socket connecting segment side forming a second wall; said first wall and said second wall are annular, and the diameter of said first wall is larger than that of said second wall; said pipe stop member is a pipe stop member with a annular shape that is circumferentially disposed; the internal diameter of said pipe stop member is larger than that of said second wall, but smaller than that of said first wall; said first O-shaped sealing ring is in sealed connection with the internal wall of said pipe stop member; said first wall works with said pipe stop member to prevent the pipe from moving in the direction of entry.

11. The pipe connector of claim 10, wherein, said pipe locking assembly comprises
a locking cap for preventing the components in said socket from escaping;
a locking cap stop member disposed at the end of said socket body where said pipe enters, for preventing said locking cap from escaping;
a demounting ring for unlocking said pipe;
a grab ring, comprising a flange and a plurality of teeth arranged on said flange and fixed to the external wall of said pipe;
a retainer, in moveable connection with the internal wall of said socket body, for stopping said grab ring from moving in the direction of pipe entry; and
a retainer stop shoulder disposed on the internal wall of said socket body for stopping said retainer from moving in the direction of pipe entry.

12. The pipe connector of claim 11, wherein the socket body comprises an O-shaped sealing ring location and a step;
said O-shaped sealing ring location is disposed between said O-shaped sealing ring stop shoulder and retainer stop shoulder;
said step is in sealed connection with said O-shaped sealing ring location;
said step is disposed at the end of said O-shaped sealing ring stop shoulder;
said O-shaped sealing ring stop shoulder is close to said third O-shaped sealing ring; and
said step always keeps in sealed connection with said O-shaped sealing ring location.

13. The pipe connector of claim 12, wherein said socket further comprises:
a locking cap stop shoulder, a convex part, and said demounting ring having a sharp angle;
said locking cap stop shoulder is disposed on the internal wall of said socket body, between said grab ring and said locking cap, for stopping said locking cap from moving in the direction of pipe entry;
said convex part is disposed on the external wall of said demounting ring for working with said locking cap to avoid said demounting ring of escaping from said socket;
said sharp angle disposed at the end of said demount ring is close to said grab ring;
the gap between said O-shaped sealing ring stop shoulder and said retainer is no narrower than the axial width of said third O-shaped sealing ring that is compressed when said pipe passes through said third O-shaped sealing ring;
the internal diameter of said teeth in their initial state is smaller than the external diameter of said pipe;
the internal diameter of said third O-shaped sealing ring is smaller than the external diameter of said pipe;
the internal diameter of said demounting ring is larger than the external diameter of said pipe;
said retainer is annular; and
said taper having a ramp that coordinates with said teeth.
